(19) United States
(12) Patent Application Publication
(10) Pub. No.: US 2023/0121292 A1
(43) Pub. Date: Apr. 20, 2023

(54) ELEVATOR SAFETY MONITORING DEVICE

(71) Applicant: Mitsubishi Electric Corporation, Tokyo (JP)

(72) Inventors: Hidetaka ISHIGURO, Tokyo (JP); Takuo KUGIYA, Tokyo (JP)

(73) Assignee: Mitsubishi Electric Corporation, Tokyo (JP)

(21) Appl. No.: 17/911,141

(22) PCT Filed: Mar. 23, 2020
(86) PCT No.: PCT/JP2020/012733

§ 371 Date: Sep. 13, 2022

(51) Int. Cl. B66B 5/00; B66B 3/00; B66B 5/02

(52) U.S. Cl. CPC B66B 5/005; B66B 3/002; B66B 5/025

(57) ABSTRACT

An elevator safety monitoring device is provided that can secure safety of a maintenance person who rides on a riding portion on a car. An elevator safety monitoring device includes an approach judgment unit which judges whether a counterweight of an elevator system approaches a car when a maintenance person is riding on a riding portion on the car of the elevator system and a safety securing unit which performs safety control for the elevator system so as to secure safety of the maintenance person when the approach judgment unit judges that the counterweight approaches the car.

### FIELD

The present disclosure relates to an elevator safety monitoring device.

### BACKGROUND

PTL 1 discloses a safety device for an elevator. The safety device can avoid a collision between a first car and a second car.

### CITATION LIST

### Patent Literature

[PTL 1] JP 2004-10272 A

### SUMMARY

### Technical Problem

However, in the safety device disclosed in PTL 1, approach between a movable body other than a car and the car is not taken into consideration. Thus, when a maintenance person performs work while riding on a riding portion on the car, it is necessary to also confirm a position of a movable body other than the car.

The present disclosure has been made to solve the above-described problems. An object of the present disclosure is to provide an elevator safety monitoring device that can secure safety of a maintenance person who rides on a riding portion on a car.

### Solution to Problem

An elevator safety monitoring device according to the present disclosure includes an approach judgment unit which judges whether a counterweight of an elevator system approaches a car when a maintenance person is riding on a riding portion on the car of the elevator system, and a safety securing unit which performs safety control for the elevator system so as to secure safety of the maintenance person when the approach judgment unit judges that the counterweight approaches the car.

An elevator safety monitoring device according to the present disclosure includes an approach judgment unit which judges whether a movable body of an elevator system approaches a first car or a second car when a maintenance person is riding on a riding portion on one of the first car and the second car in the elevator system in which the first car and the second car run while being aligned in a vertical direction or a horizontal direction, and a safety securing unit which performs safety control for the elevator system so as to secure safety of the maintenance person when the approach judgment unit judges that the movable body approaches one of the first car and the second car.

### Advantageous Effects of Invention

In the present disclosure, when a movable body other than a car approaches a car, safety control is performed. Thus, safety of a maintenance person who rides on a riding portion on the car can be secured.

### BRIEF DESCRIPTION OF DRAWINGS

FIG. 1 is a block diagram illustrating an elevator system to which an elevator safety monitoring device in a first embodiment is applied;

FIG. 2 is a vertical sectional view of principal components of the elevator system to which the elevator safety monitoring device in the first embodiment is applied;

FIG. 3 is a vertical sectional view of principal components of the elevator system to which the elevator safety monitoring device in the first embodiment is applied;

FIG. 4 is a flowchart for explaining an action of the elevator safety monitoring device in the first embodiment;

FIG. 5 is a flowchart for explaining an action of the first control device of the elevator system to which the elevator safety monitoring device in the first embodiment is applied;

FIG. 6 is a flowchart for explaining an action of the second control device of the elevator system to which the elevator safety monitoring device in the first embodiment is applied; and

FIG. 7 is a hardware block diagram illustrating the elevator safety monitoring device in the first embodiment.

### DESCRIPTION OF EMBODIMENTS

An embodiment will hereinafter be described with reference to the attached drawings. Note that the same reference characters are given to the same or corresponding components in the drawings. Descriptions thereof will appropriately be simplified or will not be repeated.

### First Embodiment

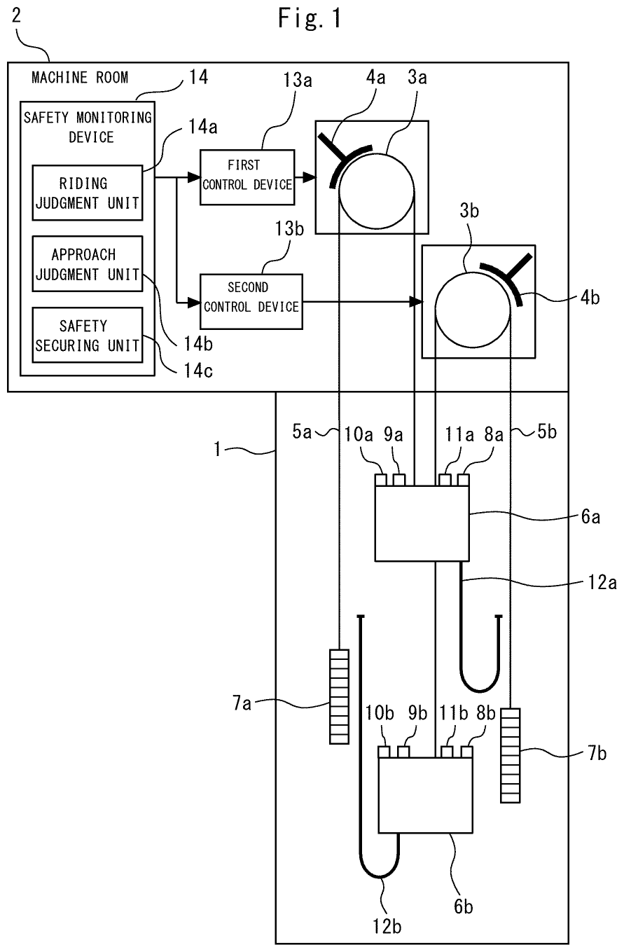

FIG. 1 is a block diagram illustrating an elevator system to which an elevator safety monitoring device in a first embodiment is applied.

In the elevator system in FIG. 1, a hoistway 1 passes through floors of a building not illustrated. A machine room 2 is provided immediately above the hoistway 1. Each of plural halls not illustrated is provided to each floor of the building. Each of the plural halls is opposed to the hoistway 1.

A first traction machine 3a is provided to the machine room 2. A first brake 4a is provided to the first traction machine 3a. A first main rope 5a is wound around the first traction machine 3a.

A second traction machine 3b is provided to the machine room 2. A second brake 4b is provided to the second traction machine 3b. A second main rope 5b is wound around the second traction machine 3b.

A first car 6a is provided to an internal portion of the hoistway 1. The first car 6a is suspended on one side of the first main rope 5a. A first counterweight 7a is provided to the internal portion of the hoistway 1. The first counterweight 7a is suspended on the other side of the first main rope 5a.

A second car 6b is provided to a lower area in the internal portion of the hoistway 1. The second car 6b is aligned with the first car 6a in a vertical direction. The second car 6b is suspended on one side of the second main rope 5b. A second counterweight 7b is provided to the internal portion of the hoistway 1. The second counterweight 7b is suspended on the other side of the second main rope 5b.

For example, a first car position sensor 8a is a governor encoder. For example, the first car position sensor 8a is an absolute position sensor such as a linear absolute encoder. The first car position sensor 8a is provided to a riding portion on the first car 6a. The first car position sensor 8a detects a position of the first car 6a. For example, the first car position sensor 8a detects a distance between the first car 6a and a landing position of a bottom floor.

A first riding detection switch 9a is provided to the riding portion on the first car 6a. The first riding detection switch 9a transmits riding information by an operation by a maintenance person.

A first operation device l0a is provided to the riding portion on the first car 6a. The first operation device l0a transmits run instruction information of the first car 6a or the second car 6b by an operation by the maintenance person.

A first notification device 11a is provided to the riding portion on the first car 6a. The first notification device 11a notifies approach of a movable body when a motion instruction is received.

For example, a second car position sensor 8b is a governor encoder. For example, the second car position sensor 8b is an absolute position sensor such as a linear absolute encoder. The second car position sensor 8b is provided to a riding portion on the second car 6b. The second car position sensor 8b detects a position of the second car 6b. For example, the second car position sensor 8b detects a distance between the second car 6b and a landing position of a bottom floor.

A second riding detection switch 9b is provided to the riding portion on the second car 6b. The second riding detection switch 9b transmits riding information by an operation by the maintenance person.

A second operation device 10b is provided to the riding portion on the second car 6b. The second operation device 10b transmits the run instruction information of the first car 6a or the second car 6b by an operation by the maintenance person.

A second notification device 11b is provided to the riding portion on the second car 6b. The second notification device 11b notifies approach of a movable body when the motion instruction is received.

One end portion of a first traveling cable 12a is connected with the first car 6a. The other end portion of the first traveling cable 12a is connected with an apparatus provided at a center in a height direction of the hoistway 1. The first traveling cable 12a forms a bending portion which is protruded downward.

One end portion of a second traveling cable 12b is connected with the second car 6b. The other end portion of the second traveling cable 12b is connected with an apparatus provided at the center in the height direction of the hoistway 1. The second traveling cable 12b forms a bending portion which is protruded downward.

A first control device 13a is provided to the machine room 2. The first control device 13a is connected with the first traction machine 3a. The first control device 13a is connected with apparatuses of the first car 6a via the first traveling cable 12a. The first control device 13a transmits control instruction information to the first traction machine 3a and the first brake 4a and thereby controls run of the first car 6a.

A second control device 13b is provided to the machine room 2. The second control device 13b is connected with the second traction machine 3b. The second control device 13b is connected with apparatuses of the second car 6b via the second traveling cable 12b. The second control device 13b transmits the control instruction information to the second traction machine 3b and the second brake 4b and thereby controls run of the second car 6b.

A safety monitoring device 14 is provided to the machine room 2. The safety monitoring device 14 is connected with the first control device 13a and the second control device 13b. The safety monitoring device 14 makes a judgment about approach among plural apparatuses of the elevator based on a detection result of the first car position sensor 8a and a detection result of the second car position sensor 8b. Based on a judgment result about approach among the plural apparatuses, the safety monitoring device 14 transmits the control instruction information to the first control device 13a and the second control device 13b.

For example, the safety monitoring device 14 includes a riding judgment unit 14a, an approach judgment unit 14b, and a safety securing unit 14c.

The riding judgment unit 14a judges whether the maintenance person is riding on the riding portion on the first car 6a based on a condition of the first riding detection switch 9a. The riding judgment unit 14a judges whether the maintenance person is riding on the riding portion on the second car 6b based on a condition of the second riding detection switch 9b.

Based on detection results of the first car position sensor 8a and the second car position sensor 8b, the approach judgment unit 14b judges whether plural movable bodies such as the first car 6a, the second car 6b, the first counterweight 7a, the second counterweight 7b, and the first traveling cable 12a approach each other.

For example, when the riding judgment unit 14a judges that the maintenance person is riding on the riding portion on the first car 6a, in a case where it is judged that any of the second car 6b, the first counterweight 7a, and the second counterweight 7b approaches the first car 6a, the safety securing unit 14c performs safety control for the elevator system so as to secure safety of the maintenance person.

For example, when the riding judgment unit 14a judges that the maintenance person is riding on the riding portion on the second car 6b, in a case where it is judged that any of the first car 6a, the first counterweight 7a, the second counterweight 7b, and the bending portion of the first traveling cable 12a approaches the second car 6b, the safety securing unit 14c performs the safety control for the elevator system so as to secure safety of the maintenance person.

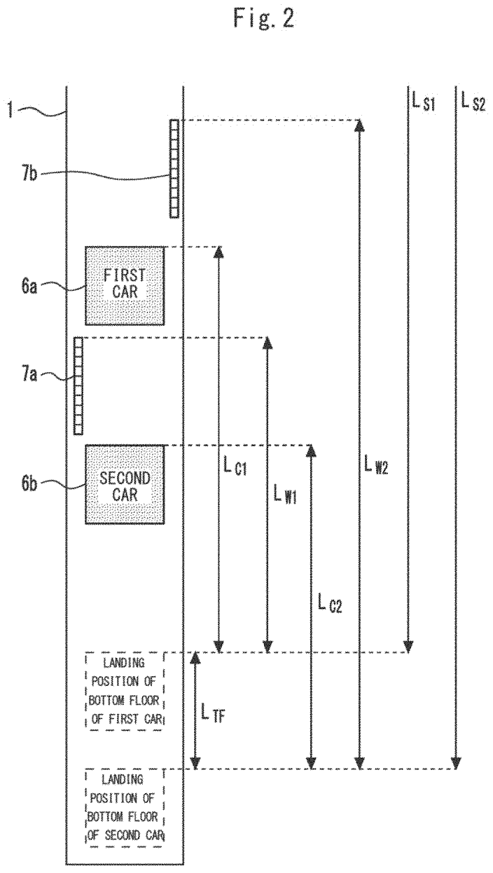

Next, by using FIG. 2, a description will be made about a method of a judgment about approach between the first car 6a or the like and the first counterweight or the like.

FIG. 2 is a vertical sectional view of principal components of the elevator system to which the elevator safety monitoring device in the first embodiment is applied.

In FIG. 2, L_{TF} denotes a distance between the landing position of the bottom floor of the first car 6a and the landing position of the bottom floor of the second car 6b.

A reference character L_{S1} denotes travel of the first car 6a. A reference character L_{C1} denotes a distance between a present position of the first car 6a and the landing position of the bottom floor. A reference character L_{W1} denotes a distance between a present position of the first counterweight 7a and the landing position of the bottom floor of the first car 6a. A reference character H_{W1} denotes a height of the first counterweight 7a.

A reference character L_{S2} denotes travel of the second car 6b. A reference character L_{C2} denotes a distance between a present position of the second car 6b and the landing position of the bottom floor. A reference character L_{W2} denotes a distance between a present position of the second counterweight 7b and the landing position of the bottom floor of the second car 6b. A reference character H_{W2} denotes a height of the first counterweight 7a.

A reference character P_{C1} denotes a distance between the present position of the first car 6a and the landing position of the bottom floor of the second car 6b. A reference character P_{W1} denotes a distance between the present position of the first counterweight 7a and the landing position of the bottom floor of the second car 6b. A reference character P_{C2} denotes a distance between the present position of the second car 6b and the landing position of the bottom floor of the second car 6b. A reference character Pw2 denotes a distance between the present position of the second counterweight 7b and the landing position of the bottom floor of the second car 6b.

A reference character S₁ denotes an approach judgment reference between the first car 6a and the second counterweight 7b. A reference character S₂ denotes an approach judgment reference between the second car 6b and the first counterweight 7a.

In FIG. 2, the following expression (1) and expression (2) hold.

L_{S1}=L_{C1}+L_{W1} (1)

L_{S2}=L_{C2}+L_{W2} (2)

Based on the expression (1) and the expression (2), the following expression (3) and expression (4) hold.

L_{W1}=L_{S1}−L_{C1} (3)

L_{W2}=L_{S2}−L_{C2} (4)

In FIG. 2, the following expression (5), expression (6), expression (7), and expression (8) hold.

P_{C1}=L_{C1}+L_{TF} (5)

P_{C2}=L_{C2} (6)

P_{W1}=L_{W1}+L_{TF} (7)

P_{W2}=L_{W2} (8)

Based on the expression (3) and the expression (7), the following expression (9) holds.

P_{W1}=L_{S1}−L_{C1}+L_{TF} (9)

Based on the expression (4) and the expression (8), the following expression (10) holds.

P_{W2}=L_{S2}−L_{C2} (10)

A distance L_{C1W1U} in a case where the first car 6a approaches the first counterweight 7a from below is expressed by the following expression (11).

L_{C1W1U}=P_{W1}−H_{W1}−P_{C1}=L_{S1}−2*L_{C1}−H_{W1} (11)

A distance L_{C1W1D} in a case where the first car 6a approaches the first counterweight 7a from above is expressed by the following expression (12).

L_{C1W1D}=P_{C1}−P_{W1}=2*L_{C1}−L_{S1} (12)

A distance L_{C1W2U} in a case where the first car 6a approaches the second counterweight 7b from below is expressed by the following expression (13).

L_{C1W2U}=P_{W2}−H_{W2}−P_{C1}−L_{S2}−L_{C2}−H_{W2}−L_{C1}−L_{TF} (13)

A distance L_{C1W2D} in a case where the first car 6a approaches the second counterweight 7b from above is expressed by the following expression (14).

L_{C1W2D}=P_{C1}−P_{W2}=L_{C1}+L_{TF}−L_{S2}+L_{C2} (14)

A distance L_{C2W2U} in a case where the second car 6b approaches the second counterweight 7b from below is expressed by the following expression (15).

L_{C2W2U}=P_{W2}−H_{W2}−P_{C2}=L_{S2}−2*L_{C2}−H_{W2} (15)

A distance L_{C2W2D} in a case where the second car 6b approaches the second counterweight 7b from above is expressed by the following expression (16).

L_{C2W2D}=P_{C2}−P_{W2}=2*L_{C2}−L_{S2} (16)

A distance L_{C2W1U} in a case where the second car 6b approaches the first counterweight 7a from below is expressed by the following expression (17).

L_{C2W1U}=P_{W1}−H_{W1}−P_{C2}−L_{S1}−L_{C1}+L_{TF}−H_{W1}−L_{C2} (17)

A distance L_{C2W1D} in a case where the second car 6b approaches the first counterweight 7a from above is expressed by the following expression (18).

L_{C2W1D}=P_{C2}−P_{W1}=L_{C2}−L_{S1}+L_{C1}−L_{TF} (18)

In a case where those distances are shorter than approach judgment references, the safety monitoring device 13 judges that the concerned movable body is approaching.

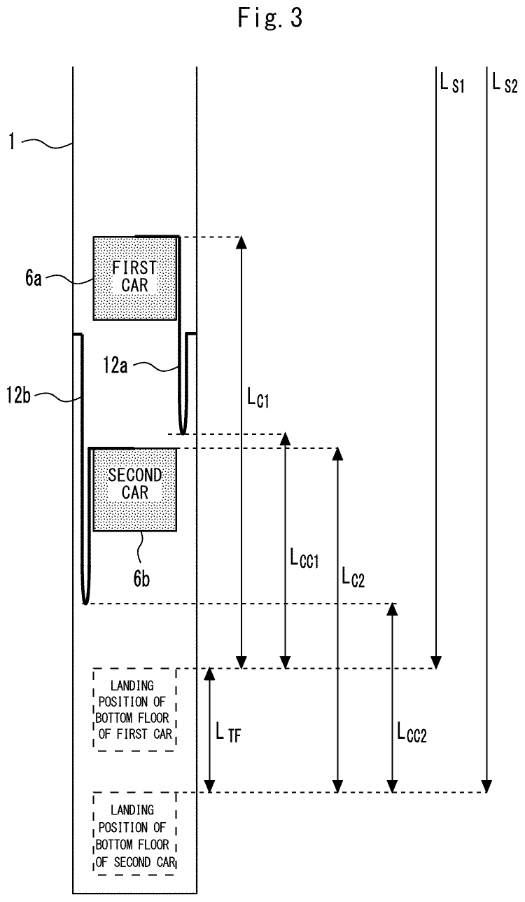

Next, by using FIG. 3, a description will be made about a method of a judgment about approach between the second car 6b and the bending portion of the first traveling cable 12a.

FIG. 3 is a vertical sectional view of principal components of the elevator system to which the elevator safety monitoring device in the first embodiment is applied.

In FIG. 3, L_{CC1} denotes a distance between a present position of the bending portion of the first traveling cable 12a and the landing position of the bottom floor of the first car 6a. A reference character L_{CC2} denotes a distance between a present position of the bending portion of the second traveling cable 12b and the landing position of the bottom floor of the second car 6b.

A reference character P_{CC1} denotes a distance between the present position of the bending portion of the first traveling cable 12a and the landing position of the bottom floor of the second car 6b. A reference character P_{CC2} denotes a distance between the present position of the bending portion of the second traveling cable 12b and the landing position of the bottom floor of the second car 6b.

In FIG. 3, the following expression (19) to expression (22) hold.

L_{CC1}=1/2*L_{C1} (19)

L_{CC2}=1/2*L_{C2} (20)

P_{C1}=L_{C1}+L_{TF} (21)

P_{C2}=L_{C2} (22)

The following expression (23) expresses P_{CC1}.

P_{CC1}=L_{CC1}+L_{TF} (23)

Based on the expression (19) and the expression (23), the following expression (24) holds.

P_{CC1}=1/2*L_{C1}+L_{TF} (24)

The following expression (25) expresses P_{CC2}.

P_{CC2}=L_{W2} (25)

Based on the expression (20) and the expression (25), the following expression (26) holds.

P_{CC2}=1/2*L_{C2} (26)

A distance L_{C2CC1U} in a case where the second car 6b approaches the bending portion of the first traveling cable 12a from below is expressed by the following expression (27).

L_{C2CC1U}=P_{CC1}−P_{C2}=1/2*L_{C2}+L_{TF}−L_{C2} (27)

In a case where those distances are shorter than approach judgment references, the safety monitoring device 13 judges that the bending portion of the first traveling cable 12a is approaching.

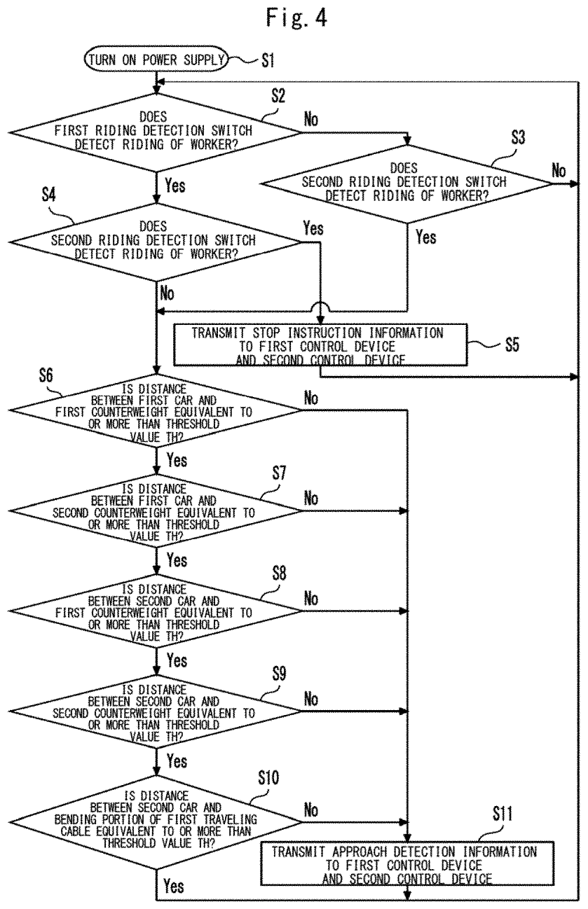

Next, an action of the safety monitoring device 14 will be described by using FIG. 4.

FIG. 4 is a flowchart for explaining an action of the elevator safety monitoring device in the first embodiment.

In step S1, in the safety monitoring device 14, power supply is turned on. Subsequently, the safety monitoring device 14 performs an action of step S2. In step S2, the safety monitoring device 14 judges whether or not the first riding detection switch 9a detects riding of the maintenance person.

In a case where the first riding detection switch 9a does not detect riding of the maintenance person in step S2, the safety monitoring device 14 performs an action of step S3. In step S3, the safety monitoring device 14 judges whether or not the second riding detection switch 9b detects riding of the maintenance person.

In a case where the second riding detection switch 9b does not detect riding of the maintenance person in step S3, a safety device performs an action of step 2.

In a case where the first riding detection switch 9a detects riding of the maintenance person in step S2, the safety monitoring device 14 performs an action of step S4. In step S4, the safety monitoring device 14 judges whether or not the second riding detection switch 9b detects riding of the maintenance person.

In a case where the second riding detection switch 9b detects riding of the maintenance person in step S4, the safety monitoring device 14 performs an action of step S5. In step S5, the safety monitoring device 14 transmits stop instruction information to the first control device 13a and the second control device 13b. Subsequently, the safety monitoring device 14 performs the action of step S2.

In a case where the second riding detection switch 9b detects riding of the maintenance person in step S3 or a case where the second riding detection switch 9b does not detect riding of the maintenance person in step S4, the safety monitoring device 14 performs an action of step S6. In step S6, the safety monitoring device 14 judges whether or not the distance between the first car 6a and the first counterweight 7a is equivalent to or more than a threshold value TH.

In a case where the distance between the first car 6a and the first counterweight 7a is equivalent to or more than the threshold value TH in step S6, the safety monitoring device 14 performs an action of step S7. In step S7, the safety monitoring device 14 judges whether or not the distance between the first car 6a and the second counterweight 7b is equivalent to or more than the threshold value TH.

In a case where the distance between the first car 6a and the second counterweight 7b is equivalent to or more than the threshold value TH in step S7, the safety monitoring device 14 performs an action of step S8. In step S8, the safety monitoring device 14 judges whether the distance between the second car 6b and the first counterweight 7a is equivalent to or more than the threshold value TH.

In a case where the distance between the second car 6b and the first counterweight 7a is equivalent to or more than the threshold value TH in step S8, the safety monitoring device 14 performs an action of step S9. In step S9, the safety monitoring device 14 judges whether the distance between the second car 6b and the second counterweight 7b is equivalent to or more than the threshold value TH.

In a case where the distance between the second car 6b and the second counterweight 7b is equivalent to or more than the threshold value TH in step S9, the safety monitoring device 14 performs an action of step S10. In step S10, the safety monitoring device 14 judges whether the distance between the second car 6b and the bending portion of the first traveling cable 12a is equivalent to or more than the threshold value TH.

In a case where the distance between the second car 6b and the bending portion of the first traveling cable 12a is equivalent to or more than the threshold value TH in step S10, the safety monitoring device 14 performs the action of step S2.

In a case where the target distances are not equivalent to or more than the threshold value TH in step S6 to step S10, the safety monitoring device 14 performs an action of step S11. In step S11, the safety monitoring device 14 transmits approach detection information to the first control device 13a and the second control device 13b. Subsequently, the safety monitoring device 14 performs the action of step S2.

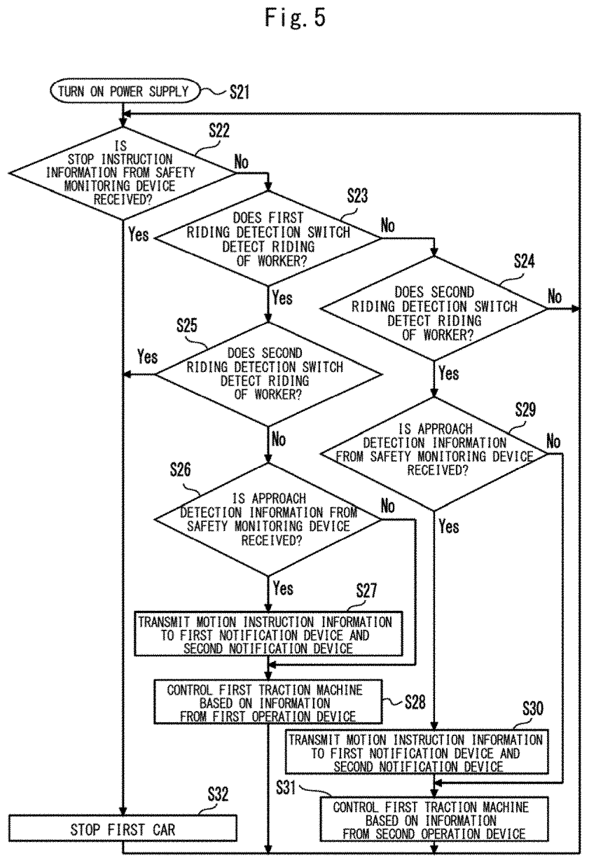

Next, an action of the first control device 13a will be described by using FIG. 5.

FIG. 5 is a flowchart for explaining an action of the first control device of the elevator system to which the elevator safety monitoring device in the first embodiment is applied.

In step S21, in the first control device 13a, power supply is turned on. Subsequently, the first control device 13a performs an action of step S22. In step S22, the first control device 13a judges whether the stop instruction information from the safety monitoring device 14 is received.

In a case where the stop instruction information from the safety monitoring device 14 is not received in step S22, the first control device 13a performs an action of step S23. In step S23, the first control device 13a judges whether the first riding detection switch 9a detects riding of the maintenance person.

In a case where the stop instruction information from the safety monitoring device 14 is not received in step S23, the first control device 13a performs an action of step S24. In step S24, the first control device 13a judges whether the second riding detection switch 9b detects riding of the maintenance person.

In a case where the second riding detection switch 9b does not detect riding of the maintenance person in step S24, the first control device 13a performs the action of step S22.

In a case where the stop instruction information from the safety monitoring device 14 is received in step S23, the first control device 13a performs an action of step S25. In step S25, the first control device 13a judges whether the second riding detection switch 9b detects riding of the maintenance person.

In a case where the second riding detection switch 9b does not detect riding of the maintenance person in step S25, the first control device 13a performs an action of step S26. In step S26, the first control device 13a judges whether the approach detection information from the safety monitoring device 14 is received.

In a case where the approach detection information from the safety monitoring device 14 is received in step S26, the first control device 13a performs an action of step S27. In step S27, the first control device 13a transmits motion instruction information to the first notification device 11a and the second notification device 11b.

In a case where the approach detection information from the safety monitoring device 14 is not received in step S26 or after step S27, the first control device 13a performs an action of step S28. In step S28, the first control device 13a controls the first traction machine 3a based on information from the first operation device 10a. Subsequently, the first control device 13a performs the action of step S22.

In a case where the second riding detection switch 9b detects riding of the maintenance person in step S24, the first control device 13a performs an action of step S29. In step S29, the first control device 13a judges whether or not the approach detection information from the safety monitoring device 14 is received.

In a case where the approach detection information from the safety monitoring device 14 is received in step S29, the first control device 13a performs an action of step S30. In step S30, the first control device 13a transmits the motion instruction information to the first notification device 11a and the second notification device 11b.

In a case where the approach detection information from the safety monitoring device 14 is not received in step S29 or after step S30, the first control device 13a performs an action of step S31. In step S31, the first control device 13a controls the first traction machine 3a based on information from the second operation device 10b. Subsequently, the first control device 13a performs the action of step S22.

In a case where the stop instruction information from the safety monitoring device 14 is received in step S22 or a case where the second riding detection switch 9b detects riding of the maintenance person in step S25, the first control device 13a performs an action of step S32. In step S32, the first control device 13a stops the first car 6a. Subsequently, the first control device 13a performs the action of step S22.

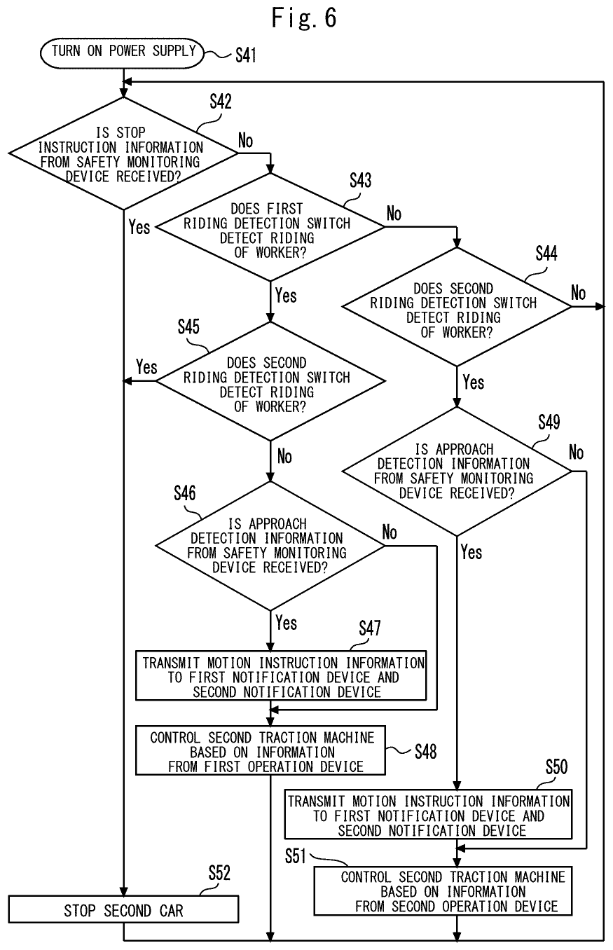

Next, an action of the second control device 13b will be described by using FIG. 6.

FIG. 6 is a flowchart for explaining an action of the second control device of the elevator system to which the elevator safety monitoring device in the first embodiment is applied.

In step S41, in the second control device 13b, power supply is turned on. Subsequently, the second control device 13b performs an action of step S42. In step S42, the second control device 13b judges whether or not the stop instruction information from the safety monitoring device 14 is received.

In a case where the stop instruction information from the safety monitoring device 14 is not received in step S42, the second control device 13b performs an action of step S43. In step S43, the second control device 13b judges whether or not the first riding detection switch 9a detects riding of the maintenance person.

In a case where the stop instruction information from the safety monitoring device 14 is not received in step S43, the second control device 13b performs an action of step S44. In step S44, the second control device 13b judges whether or not the second riding detection switch 9b detects riding of the maintenance person.

In a case where the second riding detection switch 9b does not detect riding of the maintenance person in step S44, the second control device 13b performs an action of step S42.

In a case where the stop instruction information from the safety monitoring device 14 is received in step S43, the second control device 13b performs an action of step S45. In step S45, the second control device 13b judges whether or not the second riding detection switch 9b detects riding of the maintenance person.

In a case where the second riding detection switch 9b does not detect riding of the maintenance person in step S45, the second control device 13b performs an action of step S46. In step S46, the second control device 13b judges whether or not the approach detection information from the safety monitoring device 14 is received.

In a case where the approach detection information from the safety monitoring device 14 is received in step S46, the second control device 13b performs an action of step S47. In step S47, the second control device 13b transmits the motion instruction information to the first notification device 11a and the second notification device 11b.

In a case where the approach detection information from the safety monitoring device 14 is not received in step S46 or after step S47, the second control device 13b performs an action of step S48. In step S48, the second control device 13b controls the second traction machine 3b based on information from the first operation device 10a. Subsequently, the second control device 13b performs the action of step S42.

In a case where the second riding detection switch 9b detects riding of the maintenance person in step S44, the second control device 13b performs an action of step S49. In step S49, the second control device 13b judges whether or not the approach detection information from the safety monitoring device 14 is received.

In a case where the approach detection information from the safety monitoring device 14 is received in step S49, the second control device 13b performs an action of step S50. In step S50, the second control device 13b transmits the motion instruction information to the first notification device 11a and the second notification device 11b.

In a case where the approach detection information from the safety monitoring device 14 is not received in step S49 or after step S50, the second control device 13b performs an action of step S51. In step S51, the second control device 13b controls the second traction machine 3b based on information from the second operation device 10b. Subsequently, the second control device 13b performs the action of step S42.

In a case where the stop instruction information from the safety monitoring device 14 is received in step S42 or a case where the second riding detection switch 9b does not detect riding of the maintenance person in step S45, the second control device 13b performs an action of step S52. In step S52, the second control device 13b stops the second car 6b. Subsequently, the second control device 13b performs the action of step S42.

In the above-described first embodiment, when a movable body other than the first car 6a approaches the first car 6a, the safety control is performed. When a movable body other than the second car 6b approaches the second car 6b, the safety control is performed. Thus, safety of the maintenance person who rides on the riding portion on the first car 6a or the second car 6b can be secured.

Further, in a case where the maintenance person does not ride on the riding portion on either one of the first car 6a and the second car 6b, the safety control is not performed. Thus, operation efficiency of the elevator system can be inhibited from being uselessly lowered.

Further, as the safety control, the first notification device 11a and the second notification device 11b act. Thus, the maintenance person can be notified of approach of a movable body. Note that as the safety control, only either one of the first notification device 11a and the second notification device 11a may be caused to act. In this case also, the maintenance person can be notified of approach of a movable body.

Further, a judgment about approach of a movable body is made based on travel of the elevator system, the position of the first car 6a, the position of the second car 6b, the height of the first counterweight 7a, and the height of the second counterweight 7b. Thus, a judgment about approach of a movable body can more accurately be made.

Further, as the safety control, at least one of the first car 6a and the second car 6b may be caused to temporarily stop or to temporarily decelerate. In this case, safety of the maintenance person who rides on the riding portion on the first car 6a or the second car 6b can more certainly be secured.

Further, as the safety control, one of the first car 6a and the second car 6b may be caused to temporarily stop or to temporarily decelerate, and the other of the first car 6a and the second car 6b may be caused to maintain a normal operation. In this case, while maintenance is performed in one of the first car 6a and the second car 6b, the other of the first car 6a and the second car 6b can maintain an operation of the elevator system.

Further, the other of the first car 6a and the second car 6b may be caused to maintain a decelerated operation. In this case also, safety of the maintenance person who rides on the riding portion on the first car 6a or the second car 6b can be secured.

Note that the safety monitoring device 14 of the first embodiment may be applied to an elevator system which is provided with no machine room 2 but is provided with the first traction machine 3a, the second traction machine 3b, the first control device 13a, and the second control device 13b in an upper portion or a lower portion of the hoistway 1. In this case also, safety of the maintenance person who rides on the riding portion on the first car 6a or the second car 6b can be secured.

Further, the safety monitoring device 14 of the first embodiment may be applied to an elevator system which is provided with one car. In this case, when a counterweight approaches the car, the safety control is performed. Thus, safety of the maintenance person who rides on a riding portion on the car can be secured. In particular, in an elevator with a long overhead, a counterweight approaches a car in a different position in a height direction from that of an elevator with a usual overhead. In this case also, safety of the maintenance person who rides on a riding portion on the car can be secured.

Further, the safety monitoring device 14 of the first embodiment may be applied to an elevator system in which the first car 6a and the second car 6b are aligned in a horizontal direction and which is subject to group control. In this case also, safety of the maintenance person who rides on the riding portion on the first car 6a or the second car 6b can be secured.

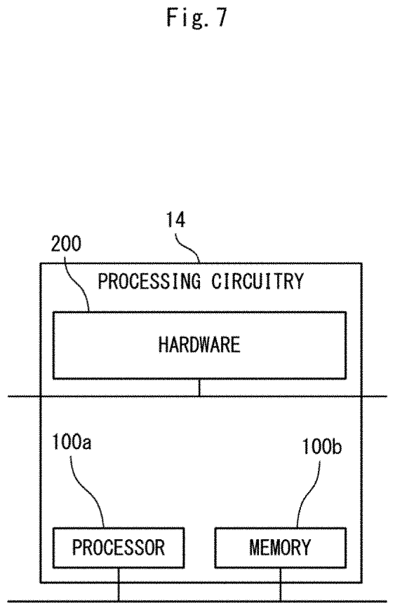

Next, an example of the safety monitoring device 14 will be described by using FIG. 7.

FIG. 7 is a hardware block diagram illustrating the elevator safety monitoring device in the first embodiment.

Each function of the safety monitoring device 14 can be realized by a processing circuit. For example, the processing circuit includes at least one processor 100a and at least one memory 100b. For example, the processing circuit includes at least one piece of dedicated hardware 200.

In a case where the processing circuit includes at least one processor 100a and at least one memory 100b, each of the functions of the safety monitoring device 14 is realized by software, firmware, or a combination of software and firmware. At least one of the software and the firmware is described as a program. At least one of the software and the firmware is stored in the at least one memory 100b. The at least one processor 100a reads out and executes a program stored in the at least one memory 100b and thereby realizes each of the functions of the safety monitoring device 14. The at least one processor 100a is also referred to as central processing unit, processing unit, arithmetic operation device, microprocessor, microcomputer, or DSP. For example, the at least one memory 100b is a non-volatile or volatile semiconductor memory such as a RAM, a ROM, a flash memory, an EPROM, or an EEPROM, a magnetic disk, a flexible disk, an optical disk, a compact disc, a MiniDisc, a DVD, or the like.

In a case where the processing circuit includes at least one piece of dedicated hardware 200, the processing circuit is realized by a single circuit, a composite circuit, a processor formed as a program, a processor formed as a parallel program, an ASIC, an FPGA, or a combination of those, for example. For example, each of the functions of the safety monitoring device 14 is realized by the processing circuit. For example, each of the functions of the safety monitoring device 14 is collectively realized by the processing circuit.

As for each of the function of the safety monitoring device 14, a part thereof may be realized by the dedicated hardware 200, and the other parts may be realized by software or firmware. For example, a function of the approach judgment unit 14b may be realized by the processing circuit as the dedicated hardware 200, and the other functions than the function of the approach judgment unit 14b may be realized by reading out and executing programs stored in the at least one memory 100b by the at least one processor 100a.

As described above, the processing circuit realizes each of the functions of the safety monitoring device 14 by the hardware 200, software, firmware, or a combination of those.

Although not illustrated, each function of the first control device 13a is realized by a processing circuit equivalent to the processing circuit which realizes each of the functions of the safety monitoring device 14. Each function of the second control device 13b is also realized by a processing circuit equivalent to the processing circuit which realizes each of the functions of the safety monitoring device 14.

### INDUSTRIAL APPLICABILITY

As described in the foregoing, an elevator safety monitoring device of the present disclosure can be used for an elevator system.

1-4. (canceled)

5. An elevator safety monitoring device comprising processing circuitry:
to judge whether a movable body of an elevator system approaches a first car or a second car when a maintenance person is riding on a riding portion on one of the first car and the second car in the elevator system in which the first car and the second car run while being aligned in a vertical direction, and
to perform safety control for the elevator system so as to secure safety of the maintenance person when the processing circuitry judges that the movable body approaches one of the first car and the second car.

6. The elevator safety monitoring device according to claim 5, wherein
the processing circuitry is configured to judge whether a maintenance person is riding on the riding portion on one of the first car and the second car, and wherein
in a case where the processing circuitry judges that no maintenance person is riding on the riding portion on one of the first car and the second car, the processing circuitry is configured not to perform the safety control for the elevator system.

7. The elevator safety monitoring device according to claim 5, wherein
the processing circuitry is configured to set counterweights which correspond to the first car and the second car or a traveling cable, as the movable bodies, and
as the safety control, the processing circuitry is configured to cause a notification device provided to the riding portion on at least one of the first car and the second car to notify approach of the movable body.

8. The elevator safety monitoring device according to claim 7, wherein the processing circuitry is configured to judge whether the movable body approaches one of the first car and the second car based on whether a distance between one of the first car and the second car and the movable body, which is represented based on travel of the elevator system, a position of the first car, a position of the second car, and heights of the counterweights, is shorter than an approach judgment reference.

9. The elevator safety monitoring device according to claim 7, wherein as the safety control, the processing circuitry is configured to cause at least one of the first car and the second car to temporarily stop or to temporarily decelerate.

10. The elevator safety monitoring device according to claim 9, wherein as the safety control, the processing circuitry is configured to cause one of the first car and the second car to temporarily stop or to temporarily decelerate and causes another of the first car and the second car to maintain a normal operation.

11. The elevator safety monitoring device according to claim 9, wherein as the safety control, the processing circuitry is configured to cause another of the first car and the second car to maintain a decelerated operation.
